(19) United States
(12) Patent Application Publication
(10) Pub. No.: US 2004/0001606 A1
(43) Pub. Date: Jan. 1, 2004

(54) Watermark fonts

(76) Inventor: Kenneth L. Levy, Stevenson, WA (US)

Correspondence Address: DIGIMARC CORPORATION, 19801 SW 72ND AVENUE, SUITE 100, TUALATIN, OR, 97062, US

(21) Appl. No.: 10/187,252

(22) Filed: Jun. 28, 2002

(51) Int. Cl. G06K 9/00

(52) U.S. Cl. 382/100

(57) ABSTRACT

A method of embedding and detecting a digital watermark in a rendered document, such as printed or displayed document, by using a watermark font. The watermark font has multiple representations of each character, wherein each character representation is visibly similar but the difference can be detected in the rendered version of the font by a computer. This watermarking system can efficiently be used to identify and forensically track all rendered, especially printed, documents. In fact, if each character is represented twice, the system can use standard ANSI characters between character codes 0 and 127, and a slightly modified version of each of these characters represented with character codes 128 to 255, such that each version of a character carries a bit. For this example, the watermark embedding process is as simple as whether or not to add 128 to the standard ANSI code. Furthermore, if the character codes are modified before the file is saved, the character codes carry the watermark within the electronic file, as well as the rendered characters carry the watermark in the rendered version.

### TECHNICAL FIELD

The invention relates to text watermarking and steganography.

### BACKGROUND AND SUMMARY

In many corporate and government organizations, there is a demand for technology that can be used to trace a printed document to the person or entity that printed it. If secure documents are leaked from the organization, this technology enables tracing of the source of the leaked copy.

One approach is to add a visible marking to the document, such as a visible copyright symbol and “printed by” notice. While such visible markings provide helpful tracing information to typical users, malicious attackers can easily remove the markings.

Invisible markings enable covert tracking and content identification. Such covert markings are harder to remove, and therefore, facilitate tracing of a leaked document to its source. This technology is sometimes referred to as “forensic tracking” because it enables one to track an object to particular source of unauthorized distribution.

One form of invisible marking for forensic tracking is a digital watermark. A related form of forensic tracking for text documents is referred to as text watermarking or text steganography. For a text document, digital watermarks for images may be used to embed a source identifier into an image of the text after it is rasterized. Rasterizing, in this context, refers to the process of converting the text from a text representation to an image representation. Specifically, the marking process starts with a conventional rasterizing of the text to image form, and then an image watermarking method is applied to embed a hidden source identifier in the image.

Previous work in text steganography recognizes that text documents have properties that enable hiding of covert data. For example, prior techniques employ character, word or line shifting to encode hidden information in the image representation of text characters. While these techniques provide for data hiding in text documents in theory, they present a number of challenges for practical implementation. In order to be an effective tracing mechanism, the hidden data must be relatively easy to integrate into existing word processing and printing systems, computationally efficient, reasonably secure to hacking, and robust to distortions caused by printing, scanning, etc.

To appreciate the technical challenges involved in effectively embedding covert markings in a text document, it is useful to examine how word processing systems operate. Word processing programs typically represent text characters in a standard format, such as ANSI. When the user saves a text document, the program stores the text characters along with formatting information, such as a specification of the type of font, line spacing and other effects in a file. While the file format and formatting codes vary from vendor to vendor, the character codes are usually represented according to a standard.

These character codes are digital numbers that correspond to a particular character. As an example, the Table shown in FIG. 1 illustrates the character codes of the ANSI standard. In ANSI, character codes are eight bit numbers, enabling 255 possible codes. As shown in FIG. 1, the character codes for numbers 0 to 9 and the letters of the alphabet, both lower and upper case, use a portion of the possible character codes (e.g., 0-127). The remaining codes (e.g., 128-255), which are referred to as extended ANSI, may be used to represent other symbols or characters from other languages.

When a user wishes to print a document, the word processing program prepares the document file for printing and sends it to a print process. Through this process, the text is transformed from character codes to an image representation for printing. A rasterizer converts each character code to an image representation base on the font type and other formatting specified in the document file. Some systems rasterize in the printer hardware, whereas others rasterize in a software driver and send the rasterized version, i.e. an image, to the printer for printing. Some systems enable users to print images displayed on the computer monitor. In this case, the word processing program, display driver or other operating system component converts the character codes to an image representation for display.

The challenge for an effective invisible, forensic tracking scheme is to hide the source identifier in the text document in a manner that integrates efficiently in this environment while still yielding a rendered document with a robust, hidden identifier. Preferably, the text document enters the process as a standard format text representation, and completes the process as a rendered document with a hidden marking. A rendered document refers to the form of the document to which it is converted for viewing, such as a printed form or displayed form

The invention provides novel methods for digitally watermarking a text document and compatible methods for extracting the digital watermark message payload from printed text. One aspect of the invention is a font watermarking method where the font includes one or more alternative image representations for the text characters in a character code set. These alterative representations correspond to hidden data symbols that may be used to embed an auxiliary message in a text document. For example, a first representation of a character represents a binary 1, while a second representation of the same character represents a binary 0. This approach may apply to a limited set of characters in an alphabet, or to all of the characters.

For forensic tracking applications, for example, the source identifier is formed from a sequence of these data symbols. To embed the source identifier, an embedder selects the image representation for each character depending on the data symbol to be hidden in that character. The data symbols may also be used to encode other information, such as calibration signals for synchronization, error detection codes, etc. In addition, due to the general nature of the auxiliary data symbols, they support sophisticated message coding schemes to enhance robustness and security. These coding schemes include spread spectrum modulation of an auxiliary message, error correction coding, synchronization coding, etc.

Another aspect of the invention is a method for detecting hidden data in a text document. This method correlates candidate image representations of a character with the image character representation scanned from the document. The candidate image representations correspond to auxiliary data symbols, such as a binary 1 or 0. Through this process, an automated reader extracts the symbols of a hidden message. For forensic tracking applications, this message may include a source identifier that identifies the person or device that rendered the document.

One implementation uses the standard character codes in ANSI to index a first version of the image representations of those characters in a watermarking font, and uses the codes allocated to extended characters to index alternative image representations of characters in a watermarking font. The standard characters index image representations in the watermarking font representing a first data symbol (e.g., a binary 1). A portion of the extended characters represent the same characters, yet index alternative image representations in the watermarking font representing a second data symbol (e.g., a binary 0). These image representations look slightly different from their counterparts in the standard set. The differences are slight enough to be substantially imperceptible, but robust enough to be distinguishable by a machine after one or more generations of printing and scanning the document. Interestingly, if the character codes are saved in the file (rather than created at rendering time), the file is watermarked by interpreting character codes below 128 as a “1” bit and character codes above 127 as a “0” bit, for this example. Thus, the file can have the watermark ID detected, and be forensically tracked, even without printing.

The dual representation of each character in the watermarking font enables each of the characters to carry data in a rendered document. Because the embedding process integrates into standard font rasterizing processes, it is efficient. In this embodiment, the only extra computation required to create the watermark is adding 128 to some characters to carry the data. The message coding may spread a binary payload over a pseudorandom sequence or other designed sequence to increase security of the message code and/or make the modifications to the document look more natural.

Further features will become apparent with reference to the following detailed description and accompanying drawings.

### BRIEF DESCRIPTION OF THE DRAWINGS

FIG. 1 illustrates a standard character code representation for text called ANSI.

FIG. 2 is a block diagram illustrating an overview of a text watermarking system.

FIG. 3 is illustrates an example of two image representations of a character in a watermarking font used to convey two different data symbols.

FIG. 4 illustrates a modified character code representation for text that includes alternative character codes that index alterative character representations in a watermarking font.

FIG. 5 illustrates a digital watermark embedding process using watermarking fonts for text documents.

FIG. 6 illustrates a digital watermark reading process compatible with the process shown in FIG. 5.

FIG. 7 illustrates the workflow for word processing and rendering of text documents in a typical computer architecture.

### DETAILED DESCRIPTION

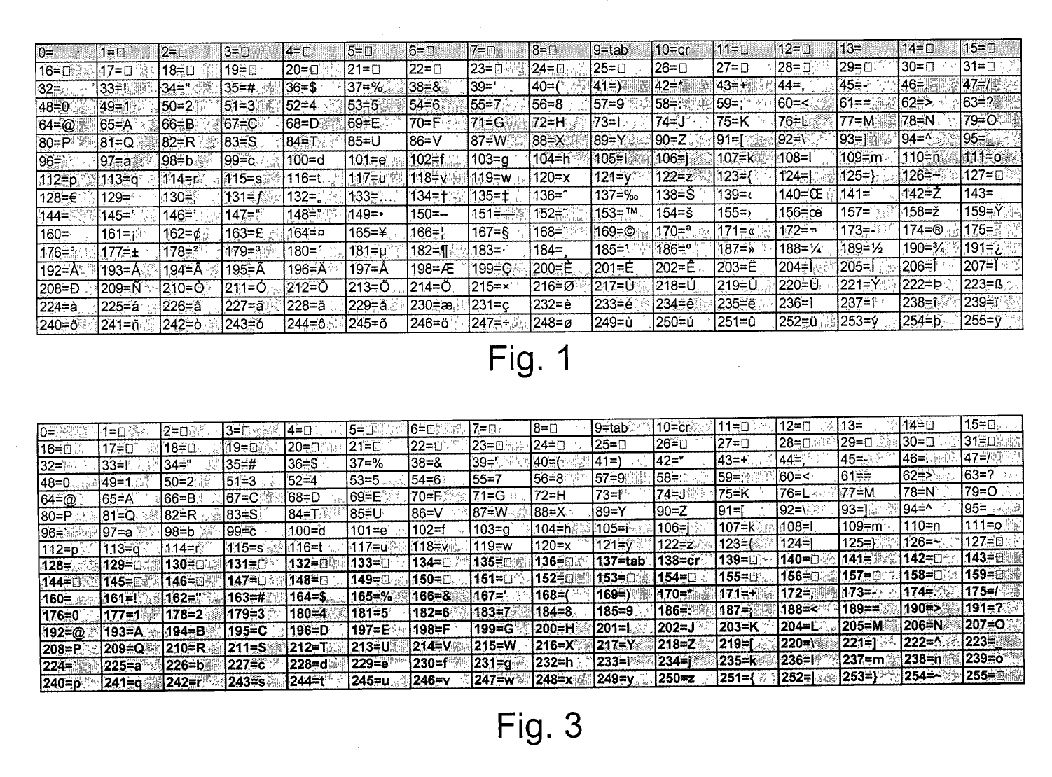

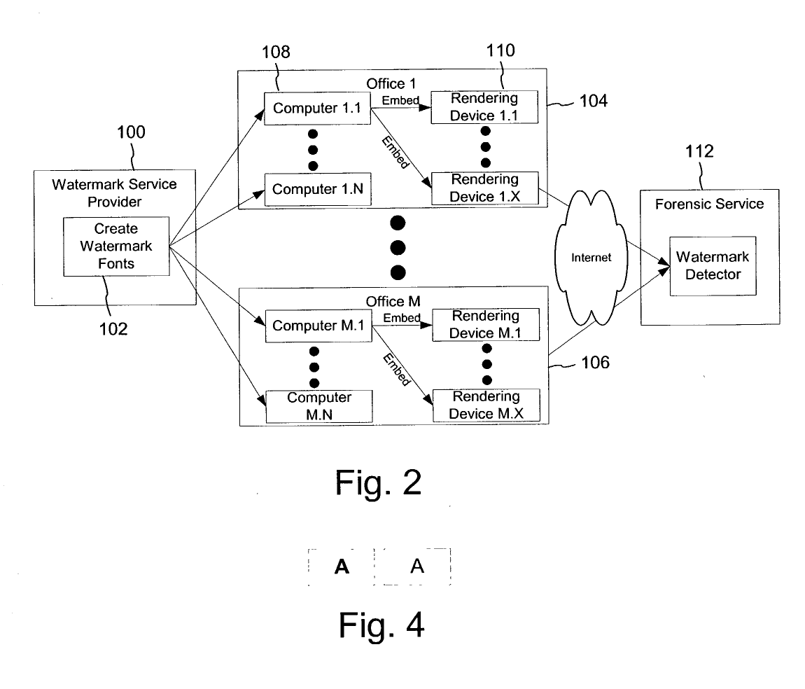

The watermarking system, as shown in FIG. 1, includes the following: a watermark service provider 100 that creates the watermarking fonts 102, offices 104-106 that use the watermarking fonts in their computers (e.g., 108) to embed the watermark in documents rendered in rendering devices (e.g., 110), and an optional forensic service provider 112, possibly the same as the watermark service provider 100, that provides forensic tracking of leaked documents, such as leaked documents found on the Internet. While it is well suited for forensic tracking applications where the system embeds a source identifier, the watermarking system supports a variety of message protocols, enabling a variety of applications. For example, the system can embed a hidden content ID to link the document to additional information, such as a database record with information about the document, an electronic file of the original, word processing document, a network address where related content or programs are stored, an internet site with related information and links, etc.

The digital watermark may convey both a document ID that is unique to the document and links to a data about the document as well as a source ID that identifies the source of the document (e.g., user, printer, and/or computer ID). In operation, the embedder issues a unique document ID for each document. The source ID, however, need only change if the source of the document changes (e.g., it's printed by different users, computers, or printers). For these applications, the embedder includes programmatic functions that communicate with a document management database that issues unique document IDs. This database may also create entries for storing an association between the document IDs and information and programmatic actions associated with the document IDs. The embedder also includes programmatic functions that obtain a source ID from a source ID generator. This source ID generator may be a database similar to the document management database, but that issues source IDs and maintains information about the source (e.g., a user name associated with the source ID, a transaction log associated with objects rendered by the source, etc.).

A digital watermark reader, such as a reader in the forensic tracking service, extracts the digital watermark payload and executes actions associated with it. Some of these actions include communicating with the document management and/or source database (either in a local or remote computer device) to provide extracted IDs and get corresponding data or programmatic actions to be performed in response to the extracted data. These programmatic actions include controlling rendering, use or transfer of the document, loading and displaying a web page with related links and information about the document, entering a transaction event in a transaction log, displaying information about the source from the source ID database (e.g., user who leaked the printed document). Of course, the extracted data may include data for display, like a source or document name, or instructions, which are interpreted and/or executed in the reader device, such as instructions to control rendering, transfer or use of the document.

Create Watermark Font

The watermark font is created and distributed to the computer before watermarking the text document. The watermarking font provides alternative versions for selected characters, and these alternative versions for each selected character represent different auxiliary data symbols used to construct the auxiliary message hidden in the rendered form of the text. Since the watermarking font already includes alternative versions that represent data symbols, the image representations of the text characters need not be changed at rendering time to embed the data symbols. Instead, the embedding process only makes a selection between alternative image representations of the text characters that are already available in the watermarking font. As such, the embedding process integrates efficiently with the rendering process.

Since the alternative image representations of characters may be indexed using character codes, the embedding process can selectively make modifications to the character codes to embed a hidden message. Later, when the character codes are rasterized into particular image representations, the character codes index an image representation of the corresponding character that carries the desired data symbol. This approach integrates into standard font rasterizing schemes because it can use a portion of the extended character code set in the ASCII or ANSI text standards to index the alternative image representations of text characters.

The structure of the watermarking font is a similar to a conventional font in that it comprises a look up table between character codes and image representations, except that the table has entries used to represent alternative representations of selected characters.

Watermarking fonts are particularly well suited for “closed” systems where an organization, such as a corporation or government agency, controls the fonts available to users of the computers on the organizations' computer networks. In such systems, the user may be provided with a variety of different watermarking fonts, such as times roman, courier, arial watermarking fonts, each having alternative versions of character representations that enable text watermarking embedding. These watermarking fonts may be loaded into each user's computer, or stored in a remote machine and accessed when a print or rendering process is requested from the user's computer.

Systems that use these watermarking fonts may be adapted for a variety of applications. These applications include publishing systems where documents are created for publication to large audiences, and desktop publishing. Another application is the use of the text watermark to convey usage restriction controls for sensitive documents, such as confidential or security classified documents in corporate or government agency computer systems. In this application, the digital watermark message can convey control instructions that control rendering, file transfer or use by certain individuals or computers, and/or at certain times and places in the organization. For example, a document with a particular security or confidentiality status may only be transferred to certain computers, may only be rendered at certain computers by authorized users, etc. The rendering control may include inhibiting rendering, or rendering in a manner that visibly marks the document to show security class information and usage rules or to obscure certain sensitive parts of the document.

Because the watermarking method can provide an embedded message in both the un-rasterized text (by modifying character codes) and rasterized text (by inserting selected image representations that convey auxiliary data, reading systems can extract the watermark and act on it for both of these types of documents. This enables applications such as forensic tracking, usage control, and linking to related information and actions (e.g., embedded ID used to look up metadata, web page or programmatic action to be taken in response to watermark detection) to be performed on both these types of documents. For example, email filters can perform the reading operation on un-rasterized text or rasterized text in email messages and attachments. This enables the email filter to control transfer of documents in the network. Also, automated searching programs can periodically scan the organizations file servers to check for text watermarked files and keep track of them, control use of them, and even delete or move them if found in authorized places. Such search programs operate by reading a file on a storage device, checking for text watermark in modified character codes, and taking appropriate action associated with the watermark message if found. The actions taken can be defined by a programmatic rule structure that defines programmatic actions to be taken as a function of the watermark message, the time/date of the file, the source of the file, the location of the file, the security or confidentiality status of the document, etc.

FIG. 3 illustrates an implementation of the character code set based on the standard character codes for ANSI text. In this implementation, half of the possible character codes (e.g., codes 0-127 in a set of 255) represent one image representation of a complete set of characters in the watermarking font, including the numbers 0 through 9 and the entire alphabet in both lower and upper case. Selected character codes in the remaining half of possible character codes represent an alternative image representation of selected characters in the first set. These alternative representations look slightly modified relative to their counterparts in the first set. The image representations in the first set correspond to a first data symbol, such as a 1, while the alternative representations of those same characters represent a second data symbol, such as a 0, or visa-versa.

Alternatively, since the complete set of character codes has 256 codes to choose from, and the required alphabet and numbers includes 62 characters (10 digits, 26 lower case letters, and 26 upper case letters), each character may be repeated 4 times for a base 4 encoding as opposed to a base 2 encoding.

An advantage of using the dual character representation is that this font will look normal on a system without the correct watermark font, watermark font creation engine, or if there is an error in the watermark font creation engine. However, this latter multicharacter representation version can carry more information since each letter can represent base-4 numbers rather than base-2 (i.e. binary).

The difference between each of the two alternative image representations of the characters can be based upon the location of the character in its display area, variations in its shape, and background shading, where different background shading of a particular character conveys different message symbols. Variations in its shape can be based upon line thickness. For example slightly thinner and thicker versions can be used to carry a bit, as shown in FIG. 4. The lines can also have a slightly pseudorandom number (PN) variation in thickness where one PN variation is a 1 and another PN variation is a 0 symbol. In another example, the tails or curvature of the letters are used to carry the data.

In addition, the background of the font can be shaded with a PN sequence to carry a data symbol. Depending on the signal characteristics of the PN sequence, this method may produce variations in the selected characters that are more likely to be visible than the location and shape variation method.

Finally, the variations in shape and location, which are mathematically describable, such as with Bezier curves can be represented in vector or TrueType/OpenType fonts, whereas many of the random and background methods have to be represented with bitmap, a.k.a. raster, fonts.

While some file formats, such as page description language (PDL) formats, may provide a page layout syntax, such as line position, the watermarking font enables more flexibility because it can represent a wider range of pre-determined variations to characters, without being limited to the syntax of the file format. Moreover, since these variations are pre-established in the watermarking font, the embedder need only look up the version of that character in the watermarking font that already has that change. The desired character variations may be indexed by the character codes such that the computational cost at the time of rasterizing is only a look up operation from character code to its image representation in the watermarking font.

Embedding for Display and Printing

The computer can choose the correct characters to embed an ID representing a content ID, rendering device, and/or user account. In the implementation shown in FIG. 3, the computer only needs to add 128 to the character to switch between a 1 and 0. These fonts carry data with electronic displays as well as paper printers. As such, a digital image of an electronic display, including a picture or print screen, will carry the data.

The ID can be carried in the document as header data, especially for a content ID. The transactional IDs, such as rendering device and/or user account can be read from the machine or rendering device and embedded at rendering.

The Message Payload

The data symbols in the message payload, such as those representing a numeric identifier, may map to individual characters in the text document. Preferably, the embedder applies robustness coding, such as repetition, error correction, etc. to generate coded symbols for embedding in the document.

Message symbols can be modulated with or otherwise represented by a pseudorandom (PN) sequence where different PN sequences represent 1's and 0's, and the combination of the PN sequence provides the ID, such as the identifier for the person printing the document.

In this case, the each embedded data bit is carried by many characters and, as such, is more robust to modification. In addition, using a PN sequence can provide security with public or private symmetric keys, where public keys allow anyone to read the watermark and private keys require the detector have the correct private key to read the watermark. The private key distribution is controlled by the key owner, and security is involved in controlling the key distribution (which is different than public key encryption). These PN sequence based payloads can also have error correction for increased robustness.

The digital watermark embedder may embed a message symbol in a group of characters, such as a word or line. This symbol may comprise a symbol in a message payload, a symbol in an error correction encoded message representing the payload, or a symbol in a modulated PN sequence or other carrier signal. For example, to embed a binary 1 symbol, all of the letter characters in a group may be modified, either relative to other characters in the document, such as in an adjacent word or line, or relative to some unmodified state. Some examples include rotating, shifting, changing line thickness, changing size, changing position of all characters in the group. In the watermarking font, modified versions of the characters (pre-rotated, pre-shifted, pre-modified in line thickness, pre-modified in size, or pre-modified in background thickness) are already available. Therefore, to make the modification, these modified versions of the characters are merely selected.

The embedding method may choose individual letters, words or lines to convey the embedded message for a number of reasons. One reason is to reduce visible artifacts due to the variations in the characters' appearance as result of the digital watermark embedding. For example, the embedder may select a sparse set of letters, only letters in the body of a word, or only particular letters (like the letters “e” or “a”). Another reason for this type of selection is to make the embedded data more difficult for hackers to discern. For example, letters, words or lines may be selected pseudorandomly, based on a secret key. A seed number may be assigned to particular user or system. This seed is then used to generate a pseudorandom sequence by a PN generator. The PN number may then select embedding locations, such as characters, words or lines, or particular types of letters. The secret key may also be a function of the document attributes. Yet another reason for selecting individual letters, characters, words, or lines is to provide reference points used to improve the accuracy of the automated reader. For example, the reader may detect a modification every Nth letter, word or character, which helps calibrate the reader to the embedded message.

Alternatively or additionally, the payload may be encrypted to provide privacy, such as with public key cryptography.

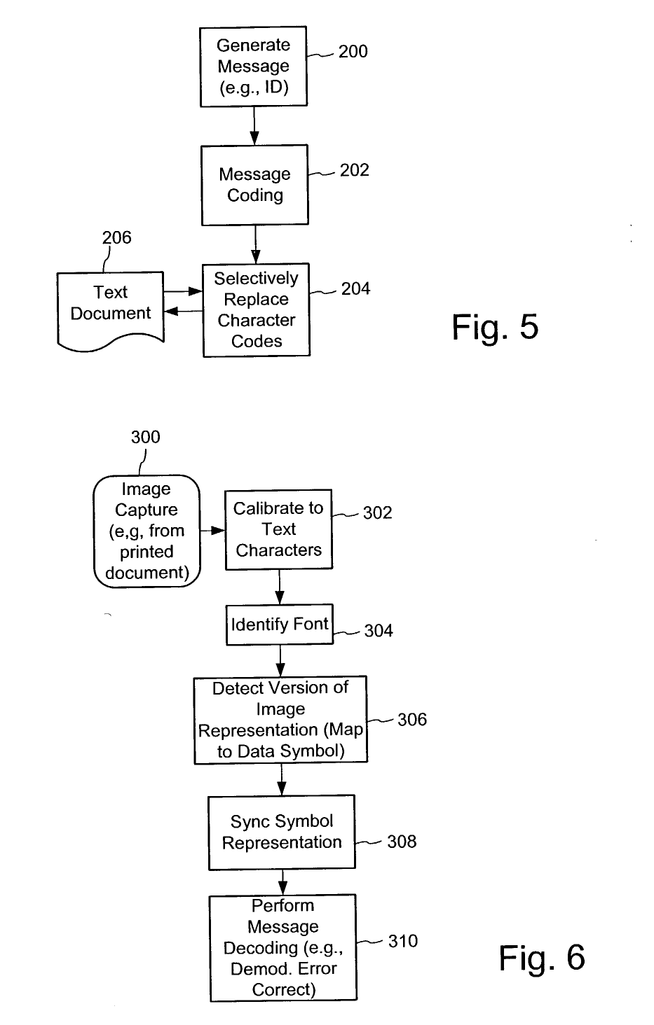

FIG. 5 is a flow diagram illustrating a process of digital watermarking using a watermark font. First, the process generates a message (200), which includes a fixed portion, and a variable payload portion that carries information that may vary from one document to the next. This variable information may include an identifier, such as a source identifier for forensic tracking, an object identifier (e.g., acting as an index to a database entry), a URL, copy control instructions, a link to a digital rights management system, etc. In this implementation, the message is a string of binary symbols. Other message symbology may be used as well, such as M-ary symbols.

For forensic tracking, there are a number of programmatic methods for assigning IDs that trace the watermarked document to its source. The ID may be a hash (e.g., CRC) of the source computer name, source user's login name, network card in the source computer, or an ID assigned by a central ID issuing database. To ensure that the ID is unique to the source, a central system may be used to check the hash generated in the source with the other IDs in the central database so that the ID does not match with other IDs already registered in the database. This database may include entries that maintain a relationship between the ID and information about the source, such as the name of the user associated with the computer or network ID card. In this context, the source corresponds to the user and/or device that initiated the rendering of the text document to be watermarked.

A similar ID assignment database may be used to manage IDs for other applications, such as linking the text documents to metadata about the documents or their creators, linking the text documents to usage control rules (such as rules controlling where and when a document can be re-produced), linking the documents to labeling instructions that ensure that each printed copy will have a visible label indicating the source, time and date of rendering, the number of the copy being printed, etc. The database may be used to keep a copy of the original document, a revision history, and a counter for each document, tracking the number of copies that have been printed and supplying the value of the counter for each instance that's printed in the system so that the copy number can be placed on a visible or invisible marking on the document.

Another part of the message that comprises a string of fixed binary symbols used to synchronize the reader of the message. This set of symbols may also be used to ensure detection of valid messages, and avoid false positives. These fixed symbols may also mark the beginning and end of various messages embedded within a document.

Another part of the message is a field for error detection codes, such as a CRC of the variable part of the message.

After generating the message, the process performs message coding to place the message in a robust and/or secure form for embedding into the text document (202). This may include error correction coding, repetition coding (repeating instance of the message), spread spectrum modulation (spreading each message symbol over a carrier signal, such as a PN sequence), encryption, etc. Message coding also includes message structuring, where individual elements are mapped to character positions in a line of text or block of text lines. This message structure may be a linear or two dimensional block that will get replicated throughout the text document.

Next, the process selectively replaces character codes in a text document (206) with character codes corresponding to the coded message (204). As noted previously, one approach is to add fixed offset to the character code, such that the resulting character code indexes the alternative character version in the watermarking font. When the text document is rasterized, either immediately following the character code modification, or at a later time, the character codes are used to index one of two possible versions of the image representations of the corresponding characters. The selection of these versions conveys the binary symbols of the coded message. The resulting rasterized version of the document, therefore, includes the message hidden within it.

A rendering device then renders the rasterized version. Rendering includes printing a physical copy on a printer, such as ink jet, laser or other type of printer. It also includes displaying on a display monitor in a “what you see is what you get” (WYSIWYG) format, where the bitmap image rendered to the screen appears as would if it were printed.

Detecting and Scaling

The detector can read the data by comparing each character to the known set. In fact, in many designs, such as including orthogonal PN sequences, measuring the similarity to one of the reference character can determine the bit by seeing if the rendered character matches the reference character or not.

The characters must be scaled to best match a representative font, or the representative font needs to be scaled to match the characters. For a uniformly scaled document, this scaling adjustment is a one-time operation, and can be updated if matches are consistently not found at a particular spatial scaling level.

Some methods, such as in moving the character position above or below a base font line, can be read without scaling the rendered document (such as printed or displayed).

In addition, if only an excerpt of a document is found, the temporal synchronization to the data payload can be accomplished by looking for the ID to repeat itself or using a known temporal synchronization pattern, such as 101010. If this synchronization pattern is short, it can be found repeating at a rate dependent upon the payload to increase verification of the synchronization.

The bits read are then used to determine the data payload, which is error corrected, and then acted upon.

FIG. 6 is a flow diagram illustrating a process for reading the digital watermark created in the process of FIG. 5 from a document. The process typically begins with capture of the image of the rendered version of the document (300). This may include a digital image scan of the rendered document, or reading an electronic, rasterized version of the document, such as a PDF or postscript type file. It is worth noting that the digital watermark may be read directly from text documents that include the modified character codes from block 204 in FIG. 5.

For rendered versions of the text document, the reader process calibrates to the position and orientation of lines of text characters (302). To calibrate on the text, the reader invokes an optical character recognition (OCR) program to perform an initial detection of the character types and orientation. Pattern matching on commonly used characters, like the letter “e” may be used to determine the orientation parameters of rotation and scale. Additionally, the OCR program may also estimate the font type, which the reader uses to retrieve the corresponding watermarking font (304). It is not necessary to identify the font for closed systems that use a single standard font. Further, it is not necessary to perform OCR recognition for all forms of embedded data, such as data embedded by modifying relative positions of characters, words or lines.

As a pre-processing optimization, the reader may employ noise removal on a digital image scanned from a document to reduce artifacts caused by usage of the document, printing or scanning.

Having identified individual characters, the reader process invokes an identification process (e.g., pattern matching such as a correlation detector) to match each individual character with the two (or more) possible alternative image representations of that character in the watermarking font (306). This provides an estimate of a 1 or 0 binary symbol, or an m-ary symbol if m-multiple characters are repeated. For the binary system, this may be hard or “soft” estimate, where the soft estimate is a weighted value indicating the likelihood that the value is 1 or 0. The soft estimate may be generated as a function of the correlation between the character image in the received document and the corresponding character image for the same character in the watermark font.

Depending on the nature of the modifications used to perform embedding, the process of extracting symbol estimates need not involve pattern matching or specifically correlation detection to match character modifications to particular embedded symbols. Other forms of symbol identification may be used. For example, if symbols are embedded by changing the orientation/position of characters, words, or lines relative to other characters, words, or lines, then the reader may extract the data symbols by computing the relative orientation/position of selected characters, lines or words. One way to compute relative positions is to compute the centroid of a character, word or line, relative to reference positions, such as centroids of other characters, words or lines. After computing the centroid, the relative positions are measured and matched to attributes corresponding to data symbol candidates. The reader estimates the embedded symbols by mapping the measured attributes to the most closely matching attributes of data symbol candidates in the data symbol set.

After generating the symbol estimates, the reader may proceed to synchronize to the start of a message instance in a block of estimated symbols (308) or proceed to perform message decoding (310) if the message is already synchronized or is self-synchronizing. For example, in one implementation, the reader performs a search for a synchronization sequence. A variation of this approach is to synchronize the data symbol sequence by correlating it with a carrier signal to detect correlation peaks that identify the origin of the message. In this latter case, the embedder modulates a message onto a carrier signal, such as a carrier PN sequence. The carrier need not be pseudorandom, but instead, can have some more regular structure or periodicity.

Once synchronized, the reader performs message decoding (310). These may include: spread spectrum demodulation of binary or M-ary message symbols from spread spectrum chips; accumulation of repeated instances of a symbol at the same bit position in the digital watermark payload; error correction decoding (inverse block codes, convolution codes, turbo codes, etc.). Ultimately, the reader passes the extracted message payload to a device, application program or other programmatic process, which acts on the data and/or instructions carried in the payload.

For forensic tracking, the payload includes a source identifier. The reader may use this identifier as an index in a central database to look-up the name and contact information for the source.

For usage control applications, the payload may include instructions or identifiers that link to instructions that control the use and further rendering of the document from which they are extracted. For example, the documents could be printed with security access levels carried in the digital watermark, such that printers and scanners would not interact with the document when the correct security code is not present. In other words, the watermark may be detected in the printer and never printed if the attached computer does not have the correct codes. Obviously, the creator has the correct codes since they are watermarking the document, but for access to scanned documents, the computer may have a lower security level than the document, and the printer can refuse to print. This is one example of how the system can work when inserting security levels in documents at rendering via a watermark font.

The processing shown in FIGS. 5-6 may be conducted at different times and within different programs or devices.

System Details

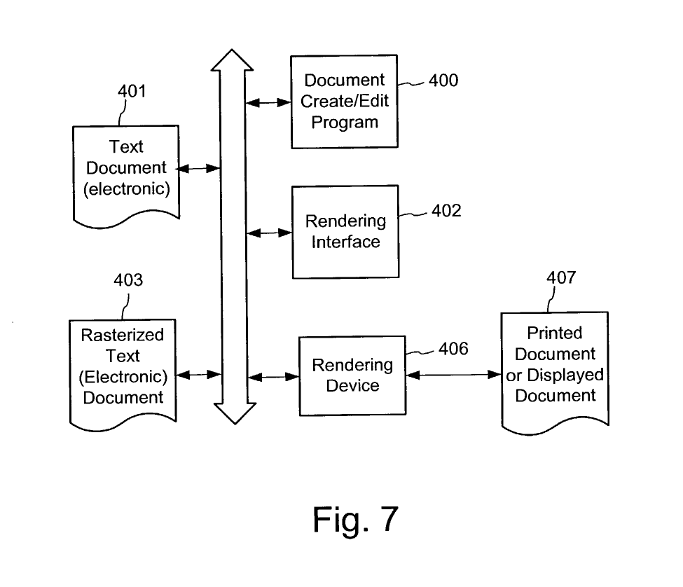

FIG. 7 is a block diagram illustrating modules of a system that implements watermarking fonts. This is a detailed example at what is happening inside the system of FIG. 1, such as between the computer 108 and rendering device 110.

The embedder operates on character codes of text documents 401 in electronic form, such as files with ANSI text stored in a computer readable memory. There are many forms of text documents, including word processing document files (e.g., Microsoft Word, Corel WordPerfect documents), PDF documents with text represented as character codes, spreadsheets, HTML files, computer source code files, etc. Similarly, there are many types of document creation and editing programs 400 that operate on these text documents. During the process of creating and editing the electronic files of these documents, the program 400 inserts or removes character codes.

When the user saves a file, the character codes are typically saved in the electronic file on persistent storage, such as a hard disk, CD, or floppy. Later, when the user enters a request to print the document, the program 400 initiates a print process. This may include pre-processing of the electronic file before sending it to a rendering interface 402, such as the operating system of the computer and/or a print driver. This pre-processing may include formatting and even rasterizing of the character codes. Also, when the document is displayed for viewing and editing, the program 400 performs preprocessing (optionally including rasterizing for display) and sends at least the portion of the document being viewed to a rendering interface 402 such as the operating system of the computer and/or display driver.

The extent of processing performed in the rendering interface 402 varies depending on the state of the electronic document at the time it is passed to the interface (e.g., whether it is pre-formatted for rendering and/or rasterized), and depending on the extent of the rasterizing conducted in the interface 402 as opposed to the rasterizing performed in the rendering device 406 (e.g., the printer or display hardware, include video card and display monitor).

In some cases, the rendering interface 402 rasterizes the character codes into corresponding image representations based on the watermarking font. In other cases, rasterizing is performed in the rendering device 406. For example, postscript printers receive postscript text and fonts and create the rasterized version at the printer, whereas inexpensive “software” printers create the rasterized version on the PC and send it to the printer for printing with minimal computations at the printer (usually just half-toning). The rasterized text 405 is an electronic form of the document where the text characters are converted to image representations for printing or display. Finally, to create a hardcopy output form of the document, a rendering device 406, such as a printer 402 prints the rasterized image onto a physical substrate, such as paper, etc. Usually, this rasterized version is a digital halftone image signal compatible with the printer hardware. To create a visual display, the display monitor converts the digital representation of the rasterized image into an analog signal for display. This digital representation usually is a multi-level per pixel image.

Within this rendering system, there are a number of opportunities to perform the embedding operations shown in FIG. 5. For embedding operations, for example, the ID and message coding may be generated in the user's computer before any documents are created or rendered. Alternatively, the ID may be generated each time the file is saved (e.g., saved under a new file name), displayed, or printed. The document creation/editing program 400 may perform the character code modification (204) when the text of a document is saved to a file on persistent storage, or as the text document is sent to a print process, such as the rendering interface 402.

Alternatively, the rendering interface 402 may perform the character code modification, whether or not it also rasterizes the text characters.

Finally, the rendering device may perform the character code modification, if the text characters have not been rasterized. The character code modification may be performed in two steps: modify the character codes; then use modified character codes to convert to rasterized version of characters. Alternatively, it may be performed in one combined step, where the rasterizer reads the input character code and corresponding coded message, and selects the rasterized version that embeds the desired hidden symbol from the coded message.

When the watermark embedding process is performed before saving the file, the digital file is actually watermarked such that the character codes carry the watermark information. The watermark detector interprets the character codes based upon whether they map to a character that represents a “1” or “0” (or m-ary code), and performs the standard message decoding after interpreting the character code. Thus, email and other electronic transfer systems can detect the watermark in the document and act appropriately. This requires developing plug-ins for every word processing or creation application used on the PC, which is easier for closed environments that can limit the PC application loading.

When the watermark embedding process is performed during the rendering interface, only the rendered versions are watermarked. However, this means that print screens and digital image captures of the screen, such as with a digital camera, have the watermark data embedded, and, after watermark detection, the system can act appropriately. In addition, this is usually the easiest place to add the watermark embedding process since it only requires monitoring the print and screen interfaces.

When the watermark embedding process is performed within the printer, the system can be made more secure if the embedding process is part of the printer hardware and not printer driver since hardware is more difficult to hack.

Certain manipulation of the text document, such as an OCR process followed by re-printing may have the effect of removing the embedded data. The impact of such operations can be mitigated by keeping the document in a closed system, where re-rendering of the document inserts another digital watermark (e.g., to identify the source). In addition, the closed system can be equipped with readers to detect when application programs are used to modify the text documents. Such events can be logged in a monitoring database, with the date, time, location, device ID, user ID, digital watermark payload, and attempted modification all logged in the database.

Concluding Remarks

Having described and illustrated the principles of the technology with reference to specific implementations, it will be recognized that the technology can be implemented in many other, different, forms. To provide a comprehensive disclosure without unduly lengthening the specification, applicants incorporate by reference the patents and patent applications referenced above.

The methods, processes, and systems described above may be implemented in hardware, software or a combination of hardware and software. For example, the auxiliary data encoding processes may be implemented in a programmable computer or a special purpose digital circuit. Similarly, auxiliary data decoding may be implemented in software, firmware, hardware, or combinations of software, firmware and hardware. The methods and processes described above may be implemented in programs executed from a system's memory (a computer readable medium, such as an electronic, optical or magnetic storage device).

The particular combinations of elements and features in the above-detailed embodiments are exemplary only; the interchanging and substitution of these teachings with other teachings in this and the incorporated-by-reference patents/applications are also contemplated.

I claim:

1. A method of embedding a digital watermark in a text document having text characters represented as character codes, the method comprising:
providing a digital message comprising message symbols;
providing a watermarking font representing text characters with sets of alternative image character representations, where the alternative image character representations correspond to different message symbols and appear similar to a viewer but are distinguishable by an automatic reader;
to hide a message symbol from the digital message in one or more text characters of the text document, selecting a predetermined image character representation of the one or more text characters corresponding to the message symbol to be hidden in the one or more text characters; and
inserting the predetermined image character representation into the text document.

2. The method of claim 1 wherein the watermarking font represents a set of text characters, and each character in the set has alternative character codes corresponding to alternative image representations for the character.

3. The method of claim 1 modifying character codes of characters in the text document so that the modified character codes identify image representations of the characters corresponding to the message symbols to be hidden in the text characters.

4. The method of claim 3 wherein modifying the character codes comprises adding a value to the character codes to compute modified character codes that index an alternative image representation of the characters in the watermarking font.

5. The method of claim 3 wherein the modifying is performed on character codes in a text document before the character codes are rasterized into image representations for printing or display.

6. The method of claim 5 wherein the modifying is performed on a text document in response to a request to render the document.

7. The method of claim 6 wherein the modifying is performed to embed a source identifier in text document, where the source identifier identifies a source of rendering the text document.

8. The method of claim 1 wherein providing the digital message includes spreading a message over a carrier signal to produce the message symbols.

9. The method of claim 8 wherein the carrier comprises a pseudorandom signal.

10. The method of claim 1 wherein providing the digital message includes error correction coding a message to produce the message symbols.

11. The method of claim 1 wherein providing the digital message includes providing a set of fixed symbols and a set of variable message symbols for embedding a variable identifier in the text document.

12. The method of claim 11 wherein the fixed symbols comprise a synchronization sequence for enabling detection of a reference point for reading the symbols in the variable message.

13. A computer readable medium including instructions for performing the method of claim 1.

14. The method of claim 1 including:
hiding the message symbols in the text document by selecting from among predetermined image representations in the watermarking font corresponding to the message symbols; and performing the hiding while saving the text document to a file such that character codes are changed in a saved file.

15. The method of claim 1 including:
hiding the message symbols in the text document by selecting from among predetermined image representations in the watermarking font corresponding to the message symbols; and performing the hiding at a rendering interface such that all rendered versions of the text document are digitally watermarked using the watermarking font.

16. The method of claim 1 including:
hiding the message symbols in the text document by selecting from among predetermined image representations in the watermarking font corresponding to the message symbols; and performing the hiding in printer hardware as the text document is being processed for printing.

17. A method of automatically reading a digital watermark from text characters in a rasterized version of a text document, the method comprising:
performing character recognition on the text characters in the rasterized version to determine font size and line orientation of the text characters in the text document; and
comparing image representations of the text characters to at least one preset character representation in a watermarking font for similarity to extract one or more auxiliary data symbols in a digital watermark message hidden in the text document.

18. The method of claim 17 where two or more preset representations of the same character are correlated to a character image found in the text document to extract a message symbol embedded in the character image.

19. A method of creating a digital watermark font comprising:
providing text characters; and
providing a set of at least two image representations for the text characters in the set, wherein the at least two image representations correspond to different data symbols and appear substantially similar to a viewer, yet are distinguishable by an automated reader.

20. The method of claim 19 with at least two versions of a set of text characters, with one version having character codes matching that of the standard ANSI character codes between 0 and 127, and another version having character codes within character codes 128 to 255, such that adding 128 to the character codes for the first version gives another version of the same character.

21. A method of reading a digital watermark embedded in a text document, the method comprising:
receiving image representations of text characters in an image representation of a text document;
for text characters in the text document, identifying which one of a set of alternative image representations of the text character in a watermarking font corresponds to the received image representation; and
extracting a sequence of message symbols embedded in the text document by finding message symbols corresponding to the identified image representation, wherein the alternative image representations for a text character appear substantially similar to a viewer but are distinguishable by an automatic reader, and correspond different message symbols.

22. The method of claim 21 including:
performing character recognition on the image representation of the text document to identify the image representations of the text characters and corresponding characters.

23. The method of claim 21 including:
processing the sequence of message symbols with a data carrier sequence to extract a message payload.

24. The method of claim 23 wherein the data carrier sequence comprises a pseudorandom number.
